(19) United States
(12) Patent Application Publication
(10) Pub. No.: US 2026/0227838 A1
(43) Pub. Date: Aug. 6, 2026

(54) COMPUTING DEVICE PROTECTION IN LOW-POWER MODE

(71) Applicant: Texas Instruments Incorporated, Dallas, TX (US)

(72) Inventors: Anand Kumar G, Bengaluru (IN); Veeramanikandan Raju, Bangalore (IN)

(21) Appl. No.: 19/042,756

(22) Filed: Jan. 31, 2025

(51) Int. Cl. G06F 1/30; G06F 1/20; G06F 1/24; G06F 1/3296

(52) U.S. Cl. CPC G06F 1/305; G06F 1/206; G06F 1/24; G06F 1/3296

(57) ABSTRACT

Methods, apparatus, systems, and articles of manufacture are described to protect a computing device in low-power mode. An example system includes temperature monitoring circuitry operable to generate a first temperature sample and a second temperature sample; and control circuitry coupled to the temperature monitoring circuitry and operable to: increment a count in response to the first temperature sample satisfying a first temperature threshold; increase the first temperature threshold to a second temperature threshold in response to the first temperature sample satisfying the first temperature threshold; compare the second temperature sample to the second temperature threshold after increasing the first temperature threshold to the second temperature threshold; and increment the count in response to the second temperature sample satisfying the second temperature threshold.

### RELATED APPLICATIONS

The present application is related to commonly assigned U.S. Pat. No. 11,847,466, titled “CONTROLLED THERMAL SHUTDOWN AND RECOVERY,” filed on Nov. 30, 2021, and U.S. Pat. No. 12,146,801, entitled “TEMPERATURE-BASED TAMPER DETECTION,” filed on Jun. 23, 2021. U.S. Pat. Nos. 11,847,466 and 12,146,801 are hereby incorporated herein by reference in their entireties.

### TECHNICAL FIELD

This description relates generally to circuits, and, more particularly, to computing device protection in low-power mode.

### BACKGROUND

Microcontrollers and/or other computing devices include processing circuitry (e.g., central processing units, graphics processing units, and/or any other type of processing units) that perform one or more operations to perform workloads, tasks, and/or functions. To conserve power, such computing devices may enter into a low-power mode, such as a standby mode, a hibernation mode, etc. In low-power, some of the components are powered down to conserve power. Other components remain active to perform minor tasks and/or cause a quick wake up to full power mode periodically, aperiodically, or based on a trigger.

### SUMMARY

For providing computing device protection in low-power mode, an example system includes temperature monitoring circuitry operable to generate a first temperature sample and a second temperature sample. The system also includes control circuitry coupled to the temperature monitoring circuitry and operable to: increment a count in response to the first temperature sample satisfying a first temperature threshold, increase the first temperature threshold to a second temperature threshold in response to the first temperature sample satisfying the first temperature threshold, compare the second temperature sample to the second temperature threshold after increasing the first temperature threshold to the second temperature threshold, and increment the count in response to the second temperature sample satisfying the second temperature threshold. Other examples are described.

For providing computing device protection in low-power mode, an example apparatus includes a first comparator operable to compare a temperature measurement to a temperature threshold. The apparatus also includes a state machine operable to: increment a count in response to the temperature measurement satisfying the temperature threshold, and increase the temperature threshold in response to the temperature measurement satisfying the temperature threshold. The apparatus also includes a second comparator operable to cause a device reset based on the count being above a count threshold. Other examples are described.

For providing computing device protection in low-power mode, an example system apparatus a power management circuit operable to generate charging pulses to provide current to a peripheral device during a low-power mode; a digital current meter coupled to the power management circuit and operable to determine a current based on the charging pulses during the low-power mode. The apparatus also includes a comparator coupled to the digital current meter and operable to cause a device reset when the current is above a threshold during the low-power mode. Other examples are described.

### BRIEF DESCRIPTION OF THE DRAWINGS

FIG. 1 is an example computing device described in conjunction with examples described herein.

FIG. 2 is a circuit diagram of an example of leakage current control circuitry and temperature monitor circuitry of FIG. 1.

FIG. 3 is a flowchart representative of a method, instructions, and/or operations that may be executed to implement the computing device of FIGS. 1-2.

FIG. 4 is a timing diagram described in conjunction with the leakage current control circuitry of FIG. 2.

FIG. 5 is an additional timing diagram described in conjunction with the leakage current control circuitry of FIG. 2.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Computing devices, such as computers, servers, IoT devices, automotive end equipment, laptops, smartphones, smart televisions, microcontrollers and/or other computing devices/electronics, are implemented in a variety of electronics to perform operations and/or tasks. Such computing devices may be split into a standard voltage threshold (SVT) portion/domain and an ultra-low leakage (ULL) always on (AON) portion/domain. The SVT portion may include processing circuitry (e.g., central processing unit(s) (CPU(s)), graphical processing unit(s) (GPU(s)), etc.), memory circuitry, high performance peripheral connections, digital radio circuitry, etc. that are implemented with SVT transistors that are high speed but have leakage current higher than ULL transistors. The ULL AON portion includes low speed peripheral devices and other always-on functionality that is implemented with ULL transistors that are lower speed but have lower leakage current than SVT transistors.

Leakage current is any non-functional current that flows when the ideal current is zero. Leakage current could be a safety hazard, deplete battery power, decrease battery life, damage equipment, cause disruption, cause signal interference, etc. While the device is programmed for a low-power mode, such as a standby mode, a deep low-power mode, a hibernation mode, etc., the SVT domain is powered off and only the ULL domain is operational.

In such computing devices, tracking and adjusting current drawn from a battery in different operating modes (e.g., active mode, a low-power mode, etc.) of the computing device is desired to ensure battery and desired product lifetime and reliability. As leakage current of the device increases with temperature, there should not be any harm, damage, and/or unreliable operations of the computing device.

In active mode of a computing device, there are techniques available for thermal management as well as for load balancing to take care of peak and average current drawn from the battery and safe/reliable operations of the computing device by cutting off the necessary circuitry. However, if the computing device operates in low-power mode, such as a standby mode, a deep low-power mode, a hibernation mode, etc. there are no techniques to monitor leakage current drawn from the battery and take appropriate action.

During low-power mode, the leakage current is dependent on operating temperature, voltage, and clock frequency. Temperature and voltage contribute to a static portion and clock frequency and associated peripheral operation contribute to a dynamic portion of the leakage current. The temperature has a stronger effect on leakage current of ULL domain, and the leakage current exponentially increases as temperature increases, especially on smaller tech nodes (e.g., 28 nanometers (nm)).

Although some techniques monitor temperature to take action to avoid an increase of leakage current during active or normal mode, such techniques may not be available during low-power mode due to the limited resources available in the ULL AON domain. For example, software-based methods may not be feasible to handle leakage current monitoring because most of the processing components in the SVT domain are turned off in low-power mode and the processing power is limited in the ULL AON domain. Examples described herein provide a low resource consumption, hardware-based temperature/current monitoring circuitry in the ULL AON domain to protect a computing device in low-power mode. Examples described herein dynamically monitor variations and/or trends temperature changes across time using hardware while operating in low-power mode.

If the leakage current variations consistently increase exponentially, the computing device can reset or fully be put into shut down to protect against computing damage of the device and/or strain on the battery. For reliable operation, the device needs to be kept in reset for cooling down effect. Examples described herein ensure that current drawn due to high temperature does not reach an alarming or unacceptable state that can reduce the battery life, due to late actions being taken on device safety. Timely intervention is critical in battery operated devices to even preserve battery life before taking safety and protection measures. Thus, examples described herein provide a low-cost, simple, low-power circuit to protect a computing device from high leakage currents during low-power mode by triggering a device reset based on the variations and/or trends in temperature.

Also, as described above, the ULL domain voltage level (e.g., 1.1 voltage (V), 1.3 V, etc.), the number of ULL domain peripherals that are concurrently operational and the frequencies (e.g., 32 kilohertz (kHz), 2 Megahertz (MHz), 16 MHz, etc.) of operations have an impact on standby current (also referred to as low-power current) consumption and/or leakage current. The leakage current is equal to a sum of (a) the static current (based on temperature and voltage) and (b) the dynamic current (based on clock frequency and peripheral operation). Thus, examples described herein ensure that current drawn due to high temperature does not reach a potentially damaging stage and/or reduce battery life by measuring the total amount of drawn current from the ULL peripheral devices during low-power mode and trigger a device reset if the total amount of current is above a threshold.

As described above, examples described herein trigger a device reset based on the temperature variation and/or standby current to protect the device and ensure reliable operation of the device and prevent further draining of battery power. Thus, examples described herein can result in extended battery life of battery-operated products that experience higher temperatures. Also, in some examples described herein, parameters such as temperature and/or current thresholds can be configurable or customizable based on user and/or manufacturer preferences, thereby providing flexibility for various use-cases.

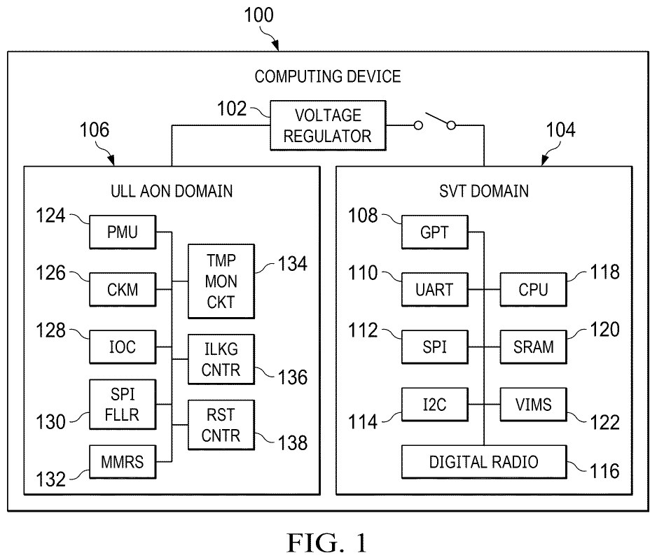

FIG. 1 illustrates an example computing device 100. The example computing device 100 includes an example voltage regulator 102, an example SVT domain 104 and an example ULL AON domain 106. The SVT domain 104 includes an example General Purpose Timer (GPT) 108, an example UART 110, an example SPI 112, an example inter-integrated circuit (I2C) 114, an example digital radio 116, an example CPU 118, example static random-access memory (SRAM) 120, and example versatile instruction memory system (VIMS) 122. The example ULL AON domain 106 includes an example power management unit (PMU) 124, an example clock module (CKM) 126, an example Input/Output Controller (IOC) 128, an example SPI follower (FLLR) 130, an example memory-mapped registers (MMRs) 132, example temperature monitoring circuitry (TMP MON CKT) 134, example leakage current (Ilkg) control circuitry (CNTR) 136, and an example reset controller (RST CNTR) 138.

The voltage regulator 102 of FIG. 1 regulates a voltage from a power source (e.g., a battery, an external power source, etc.) to one or more voltages (e.g., supply voltage(s)) suitable for the components of the SVT domain 104 and/or the ULL AON domain 106. For example, the voltage regulator 102 may include one or more direction current (DC)-to-DC converters, low drop out regulator (LDO), etc. During a normal operation, the voltage regulator 102 provides one or more supply voltages to the SVT domain 104 and the ULL AON domain 106. However, during a low-power mode, the supply voltage is not provided to the SVT domain 104 to conserve power. Rather, only the ULL AON domain 106 is operational during a low-power mode of the computing device 100.

The SVT domain 104 of FIG. 1 includes one or more devices that may be implemented with higher power consuming standard threshold voltage (SVT) transistors. For example, the GPT 108, UART 110, SPI 112, I2C 114, digital radio 116, CPU 118, SRAM 120, and/or VIMS 122 are higher power consumption and high-performance components that may implement one or more SVT transistors. However, as described above, in low-power mode, the components of the SVT domain 104 are not powered to conserve energy. After the reset controller 138 of the ULL AON domain 106 executes a reset, the computing device 100 resets and after a few clock cycles, reboot and execute user applications again using the CPU 118. After a reset, the CPU 118 may check the cause of the reset and perform thermal management while in active mode before entering back into a low-power mode. In some examples, the CPU 118 can configure how long to keep the computing device 100 in a shutdown mode. In some examples, the CPU 118 can increase the duration of a shutdown mode based on the number of resets within a duration of time.

The ULL AON domain 106 includes components utilizing ULL transistors. The ULL transistors are more efficient and consume less power than the SVT transistors but have lower performance than the SVT transistors. For example, the PMU 124, the CKM 126, the IOC 128, the SPI FLLR 130, the MMRs 132, the temperature monitoring circuitry 134, the leakage current control circuitry 136, and the reset controller 138 are lower power consumption and low-performance components that may implement one of more ULL transistors. The PMU 124 may be a dedicated integrated circuit to control and distribute power to different components/devices and/or peripheral devices/components. The PMU 124 may include transistors that are used to provide current to the different components and/or peripheral components. As further described below, the leakage current control circuitry 136 can utilize the charging pulses (also referred to as inductor charging pulses) used to drive and/or control the transistors of the PMU 124 to determine the amount of standby current being consumed by the peripheral components.

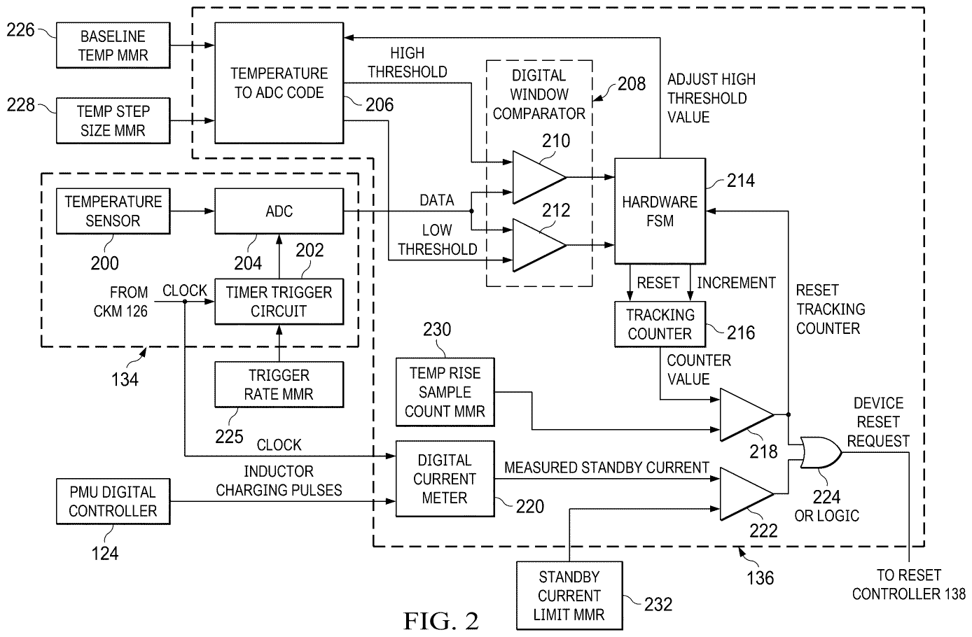

The CKM 126 of FIG. 2 generates one or more clock signals that can be used by various components of the ULL AON domain 106. The CKM 126 may include one or more oscillator(s) (e.g., clock oscillators, crystal oscillators, etc.) to generate the one or more clock signals. Oscillators are devices to generate clock signals (e.g., clock signals with different frequencies). For example, the oscillators generate a periodic signal that the leakage current control circuitry 136 can use to monitor temperature and/or leakage current.

The MMRs 132 of FIG. 1 include different registers that can store information. For example, in normal operation, a user can provide preferences for monitoring temperature and/or current via the CPU 118. The CPU 118 can cause the values corresponding to the preferences into the one or more of the MMRs 132 for use during low-power mode. As further described below in conjunction with FIG. 2, the MMRs 132 can store one or more of a baseline low temperature threshold, a baseline high temperature threshold, a temperature step size, a temperature sense trigger rate, a temperature rise sample count, and a standby current limit (e.g., maximum current threshold). For example, a user can program the temperature monitoring circuitry 134 to trigger temperature measurements at a user-defined rate (e.g., ever 256 milliseconds (ms), ever 512 ms, every second, etc.) by storing a value in the MMRs 132 that corresponds to the trigger rate. In another example, the user can program the base temperature value, the high temperature threshold, and the temperature step size into one or more of the MMRs 132. If a measurement temperature is above the base temperature value, tracking of the temperature variation is initialized. If a user wants temperature tracking from 70 degrees Celsius (C.) into steps of 1 degree C. (e.g., where the high temperature threshold is increased by 1 degree C. after every comparison), then the user can program 70 C baseline value in one of the MMRs 132 and the 1 C step size in another one of the MMRs 132. The user can also program the temperature rise sample count value into one of the MMRs 132 to determine how many consecutive temperature measurements need to be above the high temperature threshold before triggering a device reset. The MMRs 132 are further described below in conjunction with FIG. 2.

The temperature monitor circuitry 134 of FIG. 1 includes circuitry to take temperature samples that can be used to compare against one or more thresholds. For example, the temperature monitor circuitry 134 may include a temperature sensor to generate analog-based temperature measurements, an analog-to-digital converter (ADC) to convert the analog-based temperature measurements into digital temperature measurements, and timing circuitry to trigger the ADC to generate a digital temperature sample based on a temperature measurement from the temperature sensor. The temperature monitor circuitry 134 is further described below in conjunction with FIG. 2.

The leakage current control circuitry 136 of FIG. 1 triggers a reset of the computing device 100 based on monitored temperature trends and/or total standby current consumption to protect the computing device 100 and/or a battery. As described above, leakage current exponentially increases with increase in temperature. Thus, the leakage current control circuitry 136 monitors temperature variation and total standby current to prevent too much power consumption of a battery during low-power mode. Because use of software is limited in the ULL AON domain 106, the leakage current control circuitry 136 provides a hardware-based temperature monitoring circuitry that identifies steady increases of temperature over a user-defined duration of time that can be used to trigger a device reset. The reset controller 138 of FIG. 1 triggers a reset of the computing device 100 based on a reset signal from the leakage current control circuitry 136. The leakage current control circuitry 136 is further described below in conjunction with FIG. 2.

FIG. 2 is a block diagram of the example PMU 124, the example leakage current control circuitry 136, and the example temperature monitoring circuitry 134 of FIG. 1. The temperature monitoring circuitry 134 of FIG. 2 includes an example temperature sensor 200, example timer trigger circuitry 202, and an example analog-to-digital converter (ADC) 204. The leakage current control circuitry 136 includes example temperature-to-ADC code conversion circuitry 206, an example digital window comparator 208, which include two example comparators 210, 212, an example finite state machine 214, an example counter 216, an example comparator 218, an example digital current meter 220, an example comparator 222, and an example logic gate 224. FIG. 2 further includes example memory mapped registers 225, 226, 228, 230, 232, which are part of the MMRs 132 of FIG. 1.

The temperature sensor 200 of FIG. 2 senses a temperature (e.g., a silicon junction temperature) and provides the sensed temperature to the ADC 204. The temperature sensor 200 provides the sensed temperature as an analog signal that corresponds to the sensed temperature. The temperature sensor 200 is coupled to the ADC 204.

The timer trigger circuitry 202 of FIG. 2 generates a trigger or pulse at predefined points in time based on the trigger rate (e.g., every 256 ms, 512 ms, 1 second, etc.) stored in the trigger rate MMR 225. As further described below, the trigger rate MMR 225 stores a value corresponding to a user and/or manufacturer selected frequency of pulses to apply to the ADC 204. Accordingly, the timer trigger circuitry 202 accesses the trigger rate value from trigger rate MMR 225 to determine the frequency of a pulse signal to provide to the ADC 204. As further described below, the ADC 204 converts a temperature measurement at each pulse of the pulse signal. The timer trigger circuitry 202 uses the clock signal generated by the CKM 126 to generate the pulse signal. The timer trigger circuitry 202 is coupled to the CKM 126, the ADC 204, and the trigger rate MMR 225.

The ADC 204 of FIG. 2 converts the analog-based temperature measurement (e.g., signal) from the temperature sensor 200 to a digital-based temperature measurement (e.g., signal) that corresponds to the sensed temperature. Although the temperature sensor 200 may continuously send analog temperature signals to the ADC 204, the ADC 204 converts the analog signal at particular points in time based on the trigger (e.g., a pulse) from the timer trigger circuitry 202. Accordingly, based on a trigger (e.g., a pulse) from the timer trigger circuitry 202, the ADC 204 samples the analog temperature signal from the temperature sensor 200 and converts the sample into a digital value representative of the sensed temperature. The ADC 204 provides the digital temperature samples to the digital window comparator 208. The ADC 204 is coupled to the temperature sensor 200, the timer trigger circuitry 202 and the digital window comparator 208.

The temperature-to-ADC code circuitry 206 of FIG. 2 converts a user and/or manufacturer selected temperature value from a first format to a second format that corresponds to the format of the output signals of the ADC 204. The user may select at least one of a minimum temperature threshold (e.g., the baseline temperature) or a maximum temperature threshold (e.g., a user/manufactured defined initial maximum temperature threshold or the baseline temperature threshold plus the temperature step size) and a temperature step size and store the threshold(s) into the baseline temperature MMR 226 and the temperature step size in the temperature step size MMR 228. However, the format of the output of the ADC 204 may be different than the format of values stored in the MMRs 226, 228. Accordingly, the temperature-to-ADC code circuitry 206 can convert the values in the MMRs 226, 228 to the format used by the ADC 204. The temperature-to-ADC code circuitry 206 may include a lookup table that associates the user/manufacturer selected values in the first format to ADC values in the second format. In some examples, the temperature-to-ADC code circuitry 206 may convert the baseline temperature value(s) or step sizes based on prestored temperature sensor slope and offset coefficients and provide the low threshold value of the window comparator 208. Also, the temperature-to-ADC code 206 increments the user/manufacturer selected maximum temperature threshold by the temperature step size stored in the MMR 228 based on a trigger or instruction from the finite state machine 214. The temperature-to-ADC code circuitry 206 provides the ADC value that corresponds to the maximum temperature threshold to the first comparator 210 of the digital window comparator 208 and provides the ADC value that corresponds to the minimum temperature threshold to the second comparator 212 of the digital window comparator 208. The temperature-to-ADC code 206 is coupled to the digital window comparator 208, the finite state machine 214, and the MMRs 226, 228.

The digital window comparator 208 of FIG. 2 compares the sensed temperature to the minimum temperature threshold and the maximum temperature threshold. For example, the first comparator 210 compares the high temperature threshold from the temperature-to-ADC code circuitry 206 to the sensed temperature data from the ADC 204 and the second comparator 212 compares the low temperature threshold from the temperature-to-ADC code circuitry 206 to the sensed temperature from the ADC 204. If the sensed temperature signal is below the maximum temperature threshold, the comparator 210 provides a first voltage (e.g., a logic low voltage or 0 V) to the finite state machine 214. If the sensed temperature signal is above the maximum temperature threshold, the comparator 210 provides a second voltage (e.g., a logic high voltage or 1.3 V) to the finite state machine 214. The comparator 210 is coupled to the temperature-to-ADC code circuitry 206, the ADC 204, and the finite state machine 214. If the sensed temperature signal is below the minimum temperature threshold, the comparator 212 provides a first voltage (e.g., a logic low voltage or 0 V) to the finite state machine 214. If the sensed temperature signal is above the minimum temperature threshold, the comparator 212 provides a second voltage (e.g., a logic high voltage or 1.3 V) to the finite state machine 214. The comparator 212 is coupled to the temperature-to-ADC code circuitry 206, the ADC 204, and the finite state machine 214.

The finite state machine 214 of FIG. 2 is a hardware-based state machine that adjusts the tracking count and/or the maximum temperature threshold based on the output signals of the digital window comparator 208. For example, the finite state machine 214 initiates operation after the output of the second comparator 212 is a voltage that corresponds to the temperature exceeding the minimum threshold voltage. After initiated, if the output of the first comparator 210 is a voltage corresponding to the temperature exceeding the maximum temperature threshold, the finite state machine 214 provides a first signal to the tracking counter 216 to increment the tracking counter 216 by one and provides a second signal to the temperature-to-ADC code circuitry 206 to adjust the maximum temperature threshold by the temperature step size stored in the MMR 228, as further described above. If the output of the first comparator 210 is a voltage that corresponds to the temperature being below the maximum temperature threshold, the finite state machine 214 provides a first signal to the tracking counter 216 to reset the tracking count and provides a second signal to the temperature-to-ADC code circuitry 206 to reset the maximum temperature threshold to the baseline maximum temperature threshold stored in the MMR 226. Also, the finite state machine 214 may output the signals to reset the tracking count and reset the maximum temperature threshold after receiving a signal from the comparator 218 indicating that a reset is to occur. The finite state machine 214 is coupled to the temperature-to-ADC code circuitry 206, the digital window comparator 208, the tracking counter 216 and the comparator 218.

The tracking counter 216 of FIG. 2 (e.g., a 5-bit tracking counter) stores a count (also referred to as a counter value). Also, the tracking counter 216 increments and/or resets a count based on the output signals from the finite state machine 214. Initially, the count is zero. The tracking counter 216 increments the count each time the finite state machine 215 provides a signal corresponding to an increment instruction/command. If the finite state machine 214 provides a reset signal to the tracking counter 216, the tracking counter 216 resets the count back to zero. The tracking counter 216 provides the counter value to the comparator 218. The tracking counter 216 is coupled to the finite state machine 214 and the comparator 218. Although the example of FIG. 2 includes the tracking counter 216, in some examples a timer can be implemented. In such an example, the timer can be initiated based on a measured temperature exceeding the high temperature threshold. The timer can be reset if a subsequent measurement temperature is below the high temperature threshold. If the timer reaches a particular value, the comparator 218 can trigger a reset, as further described below.

The comparator 218 of FIG. 2 compares the counter value to the user/manufacturer selected temperature rise sample count stored in the MMR 230. As further described below, a user and/or manufacturer can select the temperature rise sample count and store the count in the MMR 230. The temperature rise sample count corresponds to how many consecutive high temperature readings are allowed before triggering a reset. For example, if the temperature rise sample count is four, the comparator 218 provides a first voltage (e.g., a logic low or 0 V) to the logic gate 224 and the finite state machine 214, until the counter value from the tracking counter 216 reaches four. After the comparator 218 determines that the counter value reaches the temperature rise temperature count, the comparator 218 provides a second voltage (e.g., a logic high or 1.3 V) to the finite state machine 214 and the logic gate 224 to trigger a reset and trigger the finite state machine 214 to reset the tracking count. The comparator 218 is coupled to the tracking counter 216, the MMR 230, the finite state machine 214, and the logic gate 224.

The digital current meter 220 of FIG. 2 generates a digital signal that corresponds to the total amount of standby current (also referred to as low-power current) based on inductor charging pulses from the PMU 124. The PMU 124 controls a DC-DC buck converter that is used for lower low-power current consumption (e.g., sinking and sourcing an inductor and/or peripheral device). The current meter 220 counts the number of charging pulses delivered to the inductor and/or peripheral device (e.g., based on the signal from the PMU 124) and accumulates the count over a period of time (e.g., tracked based on a clock signal from the CKM 126) to represent standby current consumption. Standby current can increase due to multiple peripheral operations at different clock frequencies. For example, an UART in follower mode can receive data at 1 MBaud and the SPI follower 130 can operate at 4 Mbps and an I2C follower can receive data at 400 kHz. The current meter 220 can output a measurement standby current value to the comparator 222 periodically, aperiodically, or based on a trigger, based on the number of charging pulses over the period of time. As described above, standby current can increase due to multiple peripheral operations at different clock frequencies. The digital current meter 220 is coupled to the CKM 126, the PMU 124 and the comparator 222.

The comparator 222 of FIG. 2 compares the measured standby current value from the digital current meter 220 to the user/manufacturer selected maximum current threshold stored in the MMR 232. As further described below, a user and/or manufacturer can select the standby current threshold and store the count in the MMR 232. The standby current threshold corresponds to maximum standby current allowed before triggering a reset. For example, if the measured standby current is below the threshold, the comparator 222 provides a first voltage (e.g., logic low or 0 V) to the logic gate 224. If the measured standby current is above the threshold, the comparator 222 provides a second voltage (e.g., logic high or 1.3 V) to the logic gate 224 to trigger a reset. The comparator 222 is coupled to the digital current meter 220, the MMR 232, and the logic gate 224.

The logic gate 224 of FIG. 2 is a logic OR gate. The logic gate 224 compares the output of the two comparators 218, 222 to trigger a reset if either one of the comparators 218, 222 provides a voltage corresponding to the counter value being above the temperate rise sample count or the measured standby current being above the standby current threshold. In this manner, if the counter value does not exceed the temperature rise sample count and the measured standby current is not above the standby current threshold, the logic gate 224 provides a first voltage (e.g., a logic low or 0 V) to the reset controller 138 to indicate that a reset is not necessary. If the counter value exceeds the temperature rise sample count or the measured standby current is above the standby current threshold, the logic gate 224 provides a second voltage (e.g., a logic high or 1.3 V) to the reset controller 138. After the reset controller 138 receives the second voltage from the logic gate 224, the reset controller 138 resets the computing device 100. The logic gate 224 is coupled to the finite state machine 214, the comparators 218, 222, and the reset controller 138.

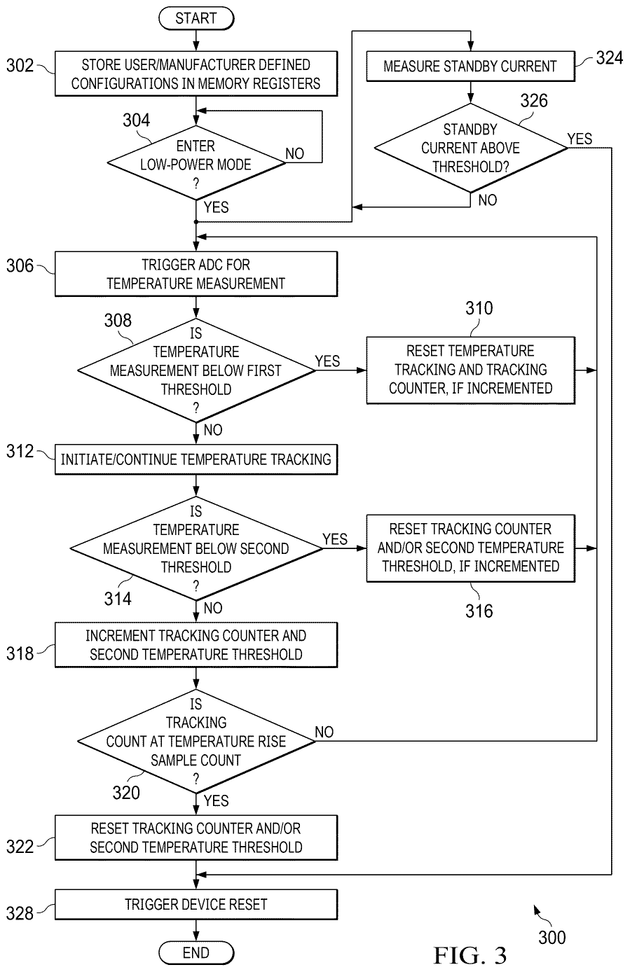

FIG. 3 is a flowchart representative of a method and/or example operations 300 that may be executed and/or instantiated by the computing device 100, the CPU 118, the PMU 124, the leakage current control circuitry 136, and/or the temperature monitoring circuitry 135 of FIGS. 1-2. The operations 300 can be performed by any one or combination of the circuitry shown in FIGS. 1-2. Although the instructions and/or operations of FIG. 3 are described in conjunction with the computing device 100 and/or ULL AON domain 106 of FIGS. 1 and 2, the instructions and/or operations may be described in conjunction with any type of circuit that implements processing circuitry. Some processes shown in FIG. 3 may be performed in orders other than described, and many processes may be performed concurrently in parallel. Furthermore, processes shown in FIG. 3 may be omitted or substituted in some examples of the present description.

The machine-readable instructions and/or the operations 300 of FIG. 3 begin at block 302, at which the CPU 118 stores the user/manufacturer defined configurations into the memory registers 132 of FIGS. 1 and 2. For example, a user or a manufacturer can define configurations by instructing the CPU 118 to store the configuration information into the registers 132 in the ULL AON domain 106. The user/manufacturer can store the baseline temperature (e.g., the minimum temperature threshold) in the baseline temperature MMR 226, the temperature step size in the temperature step size MMR 228, the temperature sensor trigger rate in the trigger rate MMR 225, the temperature rise sample count in the temperature rise sample count MMR 230, and the low-power current limit in the standby current limit MMR 232.

At block 304, the CPU 118 determines whether or not to enter low-power mode. The CPU 118 may enter low-power mode based on a duration of time of limited or no activity, user instructions, a trigger, etc. If the CPU 118 determines not to enter low-power mode (block 304: NO), control returns to block 304. If the CPU 118 determines to enter low-power mode (block 304: YES), control continues to blocks 306 and 324. In the example operations 300 of FIG. 3, blocks 306-322 and blocks 324-326 are done in parallel. However, in some examples, the instructions may be performed in series.

At block 306, the example timer trigger circuitry 202 triggers the ADC 204 to convert an analog temperature measurement to a digital temperature measurement. As further described above, the timer trigger circuitry 202 uses a clock signal from the CKM 126 and the user/manufacturer defined trigger rate stored in the trigger rate MMR 225 to trigger the ADC 204 to generate a temperature sample based on the trigger rate. The ADC 204 provides the digital temperature measurement to the digital window comparator 208. At block 308, the second comparator 212 determines whether the digital temperature measurement is below a first threshold (e.g., the baseline temperature threshold corresponding to the user/manufacturer-selected value stored in the baseline temperature MMR 226). If the comparator 212 provides a voltage corresponding to the temperature measurement being below the first threshold (block 308, YES), the hardware-based finite state machine 214 resets temperature tracking (e.g., turns off temperature tracking) and resets the tracking counter, if incremented (block 310) and control returns to block 306. If the comparator 212 provides a voltage corresponding to the temperature measurement not being below the first threshold (block 308, NO), the hardware-based finite state machine 214 is initiated or continues temperature tracking (block 312).

At block 314, the first comparator 210 determines if the temperature measurement is below a second temperature threshold (e.g., the high temperature threshold). Initially, the initial second temperature threshold may be defined by a user/manufacturer and stored in the baseline temperature MMR 226. Alternatively, the initial second temperature threshold may correspond to the baseline temperature threshold (e.g., stored in the baseline temperature threshold MMR 226) plus the temperature step size (e.g., stored in the temperature step size MMR 228). After a temperature measurement is above the second threshold, the second threshold is increased by the temperature step size, as further described below. If the first comparator 210 determines that the temperature measurement is below the second temperature threshold (block 314: YES), the finite state machine 214 resets the tracking counter 216 and/or the second temperature threshold back to the initial second temperature threshold, if the tracking count and second temperature threshold had previously been incremented (block 316) and control returns block 306.

If the first comparator 210 determines that the temperature measurement is not below the second temperature threshold (block 314: NO), the finite state machine 214 increments the tracking counter 216 and the second temperature threshold (block 318). The finite state machine 214 increments the tracking count of the tracking counter 216 by a value of ‘1’ and increments the second threshold by the temperature step size value stored in the temperature step size MMR 228.

At block 320, the comparator 218 determines if the tracking count monitored by the tracking counter 216 is greater than or equal to the temperature rise sample count stored in the temperature rise sample count MMR 230. The tracking count may function as a proxy or measure of the amount of time that the temperature exceeds the first threshold. As described above, the temperature rise sample count may be a user/manufacturer defined number of consecutive temperature measurements that exceed the increasing high temperature threshold before triggering a reset. If the comparator 218 determines that the tracking count is not at or above the temperature rise sample count (block 320: NO), control returns to block 306. If the comparator 218 determines that the tracking count is at or above the temperature rise sample count (block 320: YES), the comparator 218 provides a signal to the finite state machine 214 to reset the tracking count tracked by the tracking counter 216 back to an initial value (e.g., 0) and reset the second temperature threshold back to the initial second temperature threshold (block 322).

At block 324, the digital current meter 220 measures the low-power current. As described above, the current meter 220 counts the number of charging pulses delivered to the external inductor (e.g., based on the signal from the PMU 124) and accumulates the count over a period of time (e.g., tracked based on a clock signal from the CKM 126) to represent standby current consumption. At block 326, the comparator 222 determines if the low-power current is above a low-power current threshold (e.g., which is user/manufacture defined and stored in the standby current limit MMR 232). If the comparator 222 determines that the low-power current is not above the low-power current threshold (block 326: NO), control returns to block 324 to continue to measure/monitor low-power current. If the comparator 222 determines that the low-power current is above the low-power current threshold (block 326: YES), control continues to block 328.

At block 328 (e.g., if the tracking count is above a count threshold or if the standby current is above a standby current threshold), the logic gate 224 provides a signal to the reset controller 138 to trigger a device reset. A device reset reboots and executes a user application. In some examples, the reset can be configured by an application to stay in shut down mode for a sufficient amount of time to allow the computing device 100 to cool down, thereby protecting the computing device 100 from damage or from further draining of battery power.

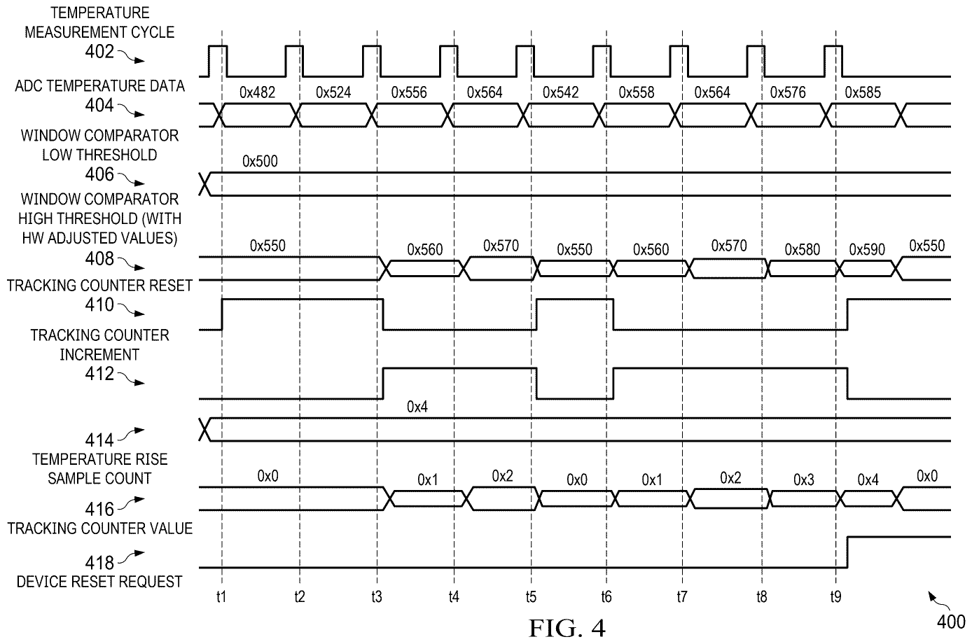

FIG. 4 is an example timing diagram 400 that corresponds to an example temperature monitoring of the leakage current control circuitry 136 of FIG. 2. FIG. 4 includes an example temperature measurement cycle signal 402, an example ADC temperature data signal 404, an example low threshold signal 406, an example high threshold signal 408, an example tracking counter reset signal 410, an example tracking counter increment signal 412, an example temperature rise sample count signal 414, an example tracking counter value signal 416, and an example device reset request signal 418. The example temperature measurement cycle signal 402 corresponds to the output of the timer trigger circuitry 202. The ADC temperature data signal 404 corresponds to the output of the ADC 204. The low threshold signal 406 corresponds to the low threshold output of the temperature-to-ADC code circuitry 206. The high threshold signal 408 corresponds to the high threshold output of the temperature-to-ADC code circuitry 206. The tracking counter reset signal 410 corresponds to the reset signal output by the finite state machine 214. The tracking counter increment signal 412 corresponds to the increment signal output by the finite state machine 214. The temperature rise sample count signal 414 corresponds to the value stored on the temperature rise sample count MMR 230. The tracking counter value signal 416 corresponds to the tracking count output by the tracking counter 216. The device reset request signal 418 corresponds to the output of the comparator 218 or the logic gate 224.

In the example of FIG. 4, the baseline low temperature threshold is 0×500 (which may correspond to 70 degrees Celsius), the baseline high temperature threshold is 0×550 (which may correspond to 75 degrees Celsius), the temperature step size is 0×010 (which may correspond to 1 degree Celsius), and the temperature rise sample count is 0×4 (which corresponds to a count of 4 consecutive samples before trigging a reset). At time t1, the temperature measurement cycle signal 402 pulses, which triggers the ADC 204 to convert an analog temperature measurement from the temperature sensor 200 to a digital value of 0×482, as shown in the ADC temperature data 404. Because the ADC temperature data 404 is less than the window comparator high threshold 408 of 0×500, the FSM machine 214 provides a high voltage for the tracking counter reset signal 410, to keep the tracking counter value 416 at 0×0.

At time t2, the ADC 204 generates the ADC temperature data signal 404 of 0×524, which is still less than the high threshold of 0×550. At time t3, the ADC temperature signal 404 of 0×556 is above the high threshold of 0×560. Thus, the finite state machine 214 increases the high threshold signal 408 to 0×560 (e.g., increasing the high temperature threshold by the temperature step size). Also, the finite state machine 214 decreases the tracking counter reset signal 410 to a low voltage and increases the tracking counter increment signal 412 to a high voltage, thereby causing the tracking counter 216 to increase the tracking counter value 416 from 0×0 to 0×1. However, because the tracking count value 416 of 0×1 is below the 0×4 threshold of the temperature rise sample count signal 414, the device reset request signal 418 is not triggered. Rather, the device reset request signal 418 remains low (e.g., 0 V). By delaying the device reset request signal 418 until the tracking count value 416 reaches the 0×4 threshold, the device can avoid a reset for a temporary rise in temperature. This approach is similar to a debouncing technique that delays a response until a stimulus persists beyond a time duration associated with transience. In other words, the device resets for a sustained (not temporary) high temperature. For these reasons, the use of tracking count value 416 can reduce false positive detections and reduce associated reset events that are caused by transient increases in temperature.

At time t4, the ADC temperature signal 404 of 0×564 is above the high threshold of 0×560. Thus, the finite state machine 214 increases the high threshold signal 408 to 0×570 (e.g., increasing the high temperature threshold by the temperature step size). Also, the finite state machine 214 maintains a high voltage for the tracking counter increment signal 412, thereby causing the tracking counter 216 to increase the tracking counter value 416 from 0×1 to 0×2. However, because the tracking count value 416 of 0×2 is below the 0×4 threshold of the temperature rise sample count signal 414, the device reset request signal 418 is not triggered.

At time t5, the ADC temperature signal 404 of 0×542 is below the high threshold of 0×570. Thus, the finite state machine 214 resets the high threshold signal 408 to 0×550. Also, the finite state machine 214 drops the tracking counter increment signal 412 to a low voltage and increases the tracking counter reset signal 410 to a high voltage, thereby causing the tracking counter 216 to reset the tracking counter value 416 to 0×0.

At times t6-t8, the ADC temperature signal 404 is above the increasing high threshold signal 408 (e.g., 0×558>0×500, 0×564>0×560, 0×576>0×570). Thus, the finite state machine 214 increases the high threshold signal 408 at times t6 to after time t8. Also, the finite state machine 214 maintains a high voltage for the tracking counter increment signal 412 and a low voltage for the tracking counter reset signal 410, thereby causing the tracking counter 216 to increase the tracking counter value 416 from 0×0 to 0×3 from times t6 to after t8.

At time t9, the ADC temperature signal 404 is above the high temperature threshold 408 (e.g., 0×585>0×580). Thus, the finite state machine 214 maintains a high voltage for the tracking counter increment signal 412 and a low voltage for the tracking counter reset signal 410, thereby causing the tracking counter 216 to increase the tracking counter value 416 from 0×3 to 0×4 after time t9. Because the tracking counter value 416 is at the temperature rise sample count value of 0×4 after time t9, the device reset request signal 418 increases to a high voltage to trigger a device reset. Also, after time t9, the window comparator high threshold signal 408 is reset to the based high threshold and the tracking counter value 416 is reset to the initial value of 0×0.

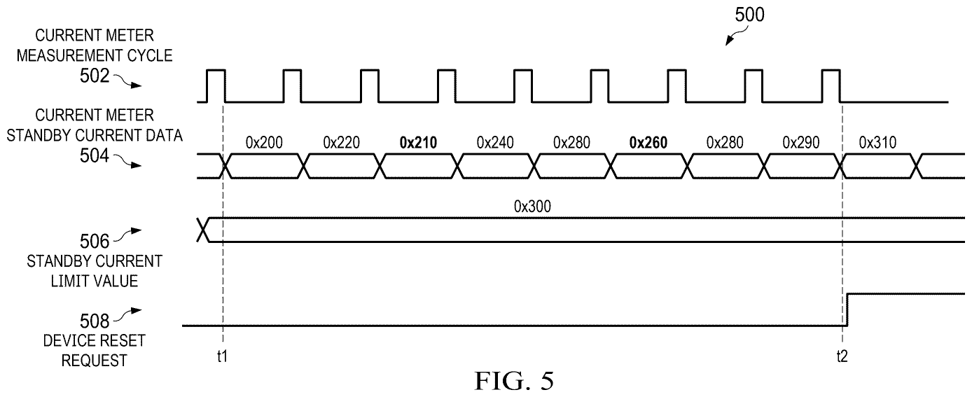

FIG. 5 is an example timing diagram 500 that corresponds to an example standby current monitoring of the leakage current control circuitry 136 of FIG. 2. FIG. 5 includes an example current meter measurement cycle signal 502, an example current meter standby current data signal 504, an example standby current limit value 506, and an example device reset request 508. The example current meter measurement cycle signal 502 corresponds to the durations of time when the digital current meter 220 of FIG. 2 samples the inductor charging pulses. The example current meter standby current data signal 504 corresponds to the standby current measurement output by the digital current meter 220. The example standby current limit value 506 corresponds to the standby current threshold used to trigger a reset and stored/output by the standby current limit MMR 232 of FIG. 2. The example device reset request 508 corresponds to the output of the comparator 222 or the logic gate 224 of FIG. 2.

At time t1, the digital current meter 220 uses the inductor charging pulses to generate a measured standby current value, as further described above in conjunction with FIG. 2. For example, the current meter standby current data 504 at time t1 adjusts to a value of 0×200. Because the standby current limit value 506 corresponds to a maximum threshold value of 0×300, at time t1, the current meter standby current data 504 value is below the standby current limit value (e.g., the maximum current threshold). For each pulse of the current meter cycle signal 502, the digital current meter 220 generates a new standby current measurement based on the clock signal and the number of inductor charging pulses. However, for each current measurement before time t2, the current meter standby current data values are below the standby current limit value. Thus, the device reset request signal 508 remains at a low voltage. At time t2, the digital current meter 220 provides a value of 0×310 for the current meter standby current data 504, which is above the standby current limit value of 0×300. Accordingly, after time t2, the comparator 222 and the logic gate 224 increase the device reset request signal 508 from a low voltage to a high voltage, thereby triggering a device reset. For example, the logic gate 224 provides the high voltage to the reset controller 138, which triggers the reset controller 138 to initiate a device reset.

An example manner of implementing the computing device 100 of FIG. 1 is illustrated in FIGS. 1-2. However, one or more of the elements, processes and/or devices illustrated in FIGS. 1-2 may be combined, divided, re-arranged, omitted, eliminated and/or implemented in any other way.

Further, the PMU 124, the CKM 126, leakage current control circuitry 136, the reset controller 138, the temperature sensor 200, the ADC 204, the timer trigger circuitry 202, the digital window comparator 208, the comparators 210, 212, 218, 222, the finite state machine 214, the tracking counter 216, the digital current meter 220, and/or the logic gate 224 of FIGS. 1-2 may be implemented by hardware, software, firmware and/or any combination of hardware, software and/or firmware. As a result, for example, any of the PMU 124, the CKM 126, leakage current control circuitry 136, the reset controller 138, the temperature sensor 200, the ADC 204, the timer trigger circuitry 202, the digital window comparator 208, the comparators 210, 212, 218, 222, the finite state machine 214, the tracking counter 216, the digital current meter 220, and/or the logic gate 224 of FIGS. 1-2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the PMU 124, the CKM 126, leakage current control circuitry 136, the reset controller 138, the temperature sensor 200, the ADC 204, the timer trigger circuitry 202, the digital window comparator 208, the comparators 210, 212, 218, 222, the finite state machine 214, the tracking counter 216, the digital current meter 222, and/or the logic date 224 of FIGS. 1-2 is/are hereby expressly defined to include a non-transitory computer readable storage device or storage disk such as a memory, a digital versatile disk (DVD), a compact disk (CD), a Blu-ray disk, etc., including the software and/or firmware. Further still, the PMU 124, the CKM 126, leakage current control circuitry 136, the reset controller 138, the temperature sensor 200, the ADC 204, the timer trigger circuitry 202, the digital window comparator 208, the comparators 210, 212, 218, 222, the finite state machine 214, the tracking counter 216, the digital current meter 222, and/or the logic date 224 of FIGS. 1-2 may include one or more elements, processes and/or devices in addition to, or instead of, those illustrated in FIGS. 1-2, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

A flowchart representative of example hardware logic, machine-readable instructions, hardware implemented state machines, and/or any combination thereof for implementing the computing device 100 of FIGS. 1-2 are shown in FIG. 3. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowchart illustrated in FIG. 3, many other methods of implementing the computing device 100 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, a field-programmable gate array (FPGA), an application-specific integrated circuit (ASIC), a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C-sharp, Perl, Python, JavaScript, HyperText Markup Language (HTML), Structured Query Language (SQL), Swift, etc.

As mentioned above, the example processes of FIG. 3 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having” and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The term “couple” “coupled”, “couples”, and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple,” “coupled,” “couples,” or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS. 1-2, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal,” “node,” “interconnect,” “pad,” and “pin” may be used interchangeably.

The terms “or” and “and/or” as used, for example, in a form such as A, B, or C or A, B, and/or C refers to any combination or subset of A, B, C such as (1) A alone, (2) B alone, (3) C alone, (4) A with B, (5) A with C, (6) B with C, or (7) A with B and with C.

Example methods, apparatus, systems, and articles of manufacture to protect a computing device in low-power mode are described herein. Further examples and combinations thereof include the following: Example 1 is a system comprising temperature monitoring circuitry operable to generate a first temperature sample and a second temperature sample, and control circuitry coupled to the temperature monitoring circuitry and operable to increment a count in response to the first temperature sample satisfying a first temperature threshold, increase the first temperature threshold to a second temperature threshold in response to the first temperature sample satisfying the first temperature threshold, compare the second temperature sample to the second temperature threshold after increasing the first temperature threshold to the second temperature threshold, and increment the count in response to the second temperature sample satisfying the second temperature threshold.

Example 2 includes the system of example 1, wherein the control circuitry is operable to increment the count during a low-power mode, wherein the control circuitry is operable to increase the first temperature threshold to the second temperature threshold during the low-power mode, and wherein the control circuitry is operable to compare the second temperature sample to the second temperature threshold during the low-power mode.

Example 3 includes the system of example 1, wherein the control circuitry is operable to compare the second temperature sample to the second temperature threshold in response to the count not satisfying a count threshold.

Example 4 includes the system of example 1, wherein the control circuitry is operable to cause a device reset based on the count satisfying a count threshold.

Example 5 includes the system of example 4, wherein the first temperature threshold and the count threshold are user defined.

Example 6 includes the system of example 1 wherein a step size between the first temperature threshold and the second temperature threshold is user defined.

Example 7 includes the system of example 1, wherein the temperature monitoring circuitry is operable to generate a third temperature sample prior to generating the first temperature sample and the second temperature sample, and the control circuitry operable to, during a low-power mode, after the third temperature sample does not satisfy the second temperature threshold, reset the count and decrease the second temperature threshold to the first temperature threshold.

Example 8 includes the system of example 1, further including a power management circuit operable to generate charging pulses to provide a current to a peripheral device, wherein the control circuitry is operable to determine the current based on the charging pulses, and cause a device reset based on the current being above a threshold.

Example 9 includes the system of example 1, wherein the control circuitry is operable to reset the count and decrease the second temperature threshold to the first temperature threshold based on the count satisfying a count threshold.

Example 10 includes an apparatus comprising a first comparator operable to compare a temperature measurement to a temperature threshold, a state machine operable to increment a count in response to the temperature measurement satisfying the temperature threshold, and increase the temperature threshold in response to the temperature measurement satisfying the temperature threshold, and a second comparator operable to cause a device reset based on the count being above a count threshold.

Example 11 includes the apparatus of example 10, wherein the first comparator is operable to compare the temperature measurement to the temperature threshold during a low-power mode, wherein the state machine is operable to increment the count and the temperature threshold during the low-power mode, and wherein the second comparator is operable to cause the device reset during the low-power mode.

Example 12 includes the apparatus of example 10, wherein the state machine is operable to decrease the temperature threshold based on the temperature measurement being below the temperature threshold.

Example 13 includes the apparatus of example 10, wherein the temperature measurement is a first measurement, wherein the first comparator is operable to compare a second temperature measurement to the temperature threshold, and the state machine is operable to reset the count based on the second temperature measurement being below the temperature threshold.

Example 14 includes the apparatus of example 13, wherein the first comparator is operable to compare the second temperature measurement to the temperature threshold in response to the count not satisfying the count threshold.

Example 15 includes the apparatus of example 10, further including a current meter operable to determine a current supplied to a load based on charging pulses from a power management unit, and a third comparator operable to cause the device reset based on the current being above a current threshold.

Example 16 includes the apparatus of example 10, wherein the temperature measurement is a digital-based temperature measurement, further including an analog-to-digital converter operable to convert an analog temperature measurement to the digital-based temperature measurement.

Example 17 includes the apparatus of example 16, wherein the analog-to-digital converter is operable to sample analog based temperature measurements at a user-defined rate.

Example 18 includes the apparatus of example 17, wherein the analog-to-digital converter generates the temperature measurement in a first format, further including a lookup table to convert the temperature threshold from a second format to the first format.

Example 19 includes an apparatus comprising a power management circuit operable to generate charging pulses to provide current to a peripheral device during a low-power mode, a digital current meter coupled to the power management circuit and operable to determine a current based on the charging pulses during the low-power mode, and a comparator coupled to the digital current meter and operable to cause a device reset when the current is above a threshold during the low-power mode.

Example 20 includes the apparatus of example 19, wherein the power management circuit is to generate the charging pulses to drive transistors to source or sink current for the peripheral device.

Modifications are possible in the described embodiments, and other embodiments are possible, within the scope of the claims.

What is claimed is:

1. A system comprising:
temperature monitoring circuitry operable to generate a first temperature sample and a second temperature sample; and
control circuitry coupled to the temperature monitoring circuitry and operable to:
increment a count in response to the first temperature sample satisfying a first temperature threshold;
increase the first temperature threshold to a second temperature threshold in response to the first temperature sample satisfying the first temperature threshold;
compare the second temperature sample to the second temperature threshold after increasing the first temperature threshold to the second temperature threshold; and
increment the count in response to the second temperature sample satisfying the second temperature threshold.

2. The system of claim 1,
wherein the control circuitry is operable to increment the count during a low-power mode,
wherein the control circuitry is operable to increase the first temperature threshold to the second temperature threshold during the low-power mode, and
wherein the control circuitry is operable to compare the second temperature sample to the second temperature threshold during the low-power mode.

3. The system of claim 1, wherein the control circuitry is operable to compare the second temperature sample to the second temperature threshold in response to the count not satisfying a count threshold.

4. The system of claim 1, wherein the control circuitry is operable to cause a device reset based on the count satisfying a count threshold.

5. The system of claim 4, wherein the first temperature threshold and the count threshold are user defined.

6. The system of claim 1 wherein a step size between the first temperature threshold and the second temperature threshold is user defined.

7. The system of claim 1, wherein:
the temperature monitoring circuitry is operable to generate a third temperature sample prior to generating the first temperature sample and the second temperature sample; and
the control circuitry operable to, during a low-power mode, after the third temperature sample does not satisfy the second temperature threshold, reset the count and decrease the second temperature threshold to the first temperature threshold.

8. The system of claim 1, further including a power management circuit operable to generate charging pulses to provide a current to a peripheral device, wherein the control circuitry is operable to:
determine the current based on the charging pulses; and
cause a device reset based on the current being above a threshold.

9. The system of claim 1, wherein the control circuitry is operable to reset the count and decrease the second temperature threshold to the first temperature threshold based on the count satisfying a count threshold.

10. An apparatus comprising:
a first comparator operable to compare a temperature measurement to a temperature threshold;
a state machine operable to:
increment a count in response to the temperature measurement satisfying the temperature threshold; and
increase the temperature threshold in response to the temperature measurement satisfying the temperature threshold; and
a second comparator operable to cause a device reset based on the count being above a count threshold.

11. The apparatus of claim 10,
wherein the first comparator is operable to compare the temperature measurement to the temperature threshold during a low-power mode,
wherein the state machine is operable to increment the count and the temperature threshold during the low-power mode, and
wherein the second comparator is operable to cause the device reset during the low-power mode.

12. The apparatus of claim 10, wherein the state machine is operable to decrease the temperature threshold based on the temperature measurement being below the temperature threshold.

13. The apparatus of claim 10, wherein the temperature measurement is a first measurement, wherein:
the first comparator is operable to compare a second temperature measurement to the temperature threshold; and
the state machine is operable to reset the count based on the second temperature measurement being below the temperature threshold.

14. The apparatus of claim 13, wherein the first comparator is operable to compare the second temperature measurement to the temperature threshold in response to the count not satisfying the count threshold.

15. The apparatus of claim 10, further including:
a current meter operable to determine a current supplied to a load based on charging pulses from a power management unit; and
a third comparator operable to cause the device reset based on the current being above a current threshold.

16. The apparatus of claim 10, wherein the temperature measurement is a digital-based temperature measurement, further including an analog-to-digital converter operable to convert an analog temperature measurement to the digital-based temperature measurement.

17. The apparatus of claim 16, wherein the analog-to-digital converter is operable to sample analog based temperature measurements at a user-defined rate.

18. The apparatus of claim 17, wherein the analog-to-digital converter generates the temperature measurement in a first format, further including a lookup table to convert the temperature threshold from a second format to the first format.

19. An apparatus comprising:
a power management circuit operable to generate charging pulses to provide current to a peripheral device during a low-power mode;
a digital current meter coupled to the power management circuit and operable to determine a current based on the charging pulses during the low-power mode; and
a comparator coupled to the digital current meter and operable to cause a device reset when the current is above a threshold during the low-power mode.

20. The apparatus of claim 19, wherein the power management circuit is to generate the charging pulses to drive transistors to source or sink current for the peripheral device.
